(19) United States
(12) Patent Application Publication
(10) Pub. No.: US 2008/0183821 A1
(43) Pub. Date: Jul. 31, 2008

(54) Apparatus and method for receiving signals in a communication system

(75) Inventors: Sung-Eun Park, Seoul (KR); Dong-Seek Park, Yongin-si (KR); Jae-Yeol Kim, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/012,152

(22) Filed: Jan. 30, 2008

(30) Foreign Application Priority Data
Jan. 30, 2007 (KR) 2007-9491

(51) Int. Cl. G06F 15/16

(52) U.S. Cl. 709/205

(57) ABSTRACT

Provided is an apparatus and method for receiving signals in a communication system. A first processor inputs dc input messages through dc input nodes, respectively, generates one output message from the dc input messages using a predetermined operation scheme, and outputs the output message to dc output nodes. A corrector inputs output messages output from the dc output nodes through dv input nodes, corrects the input dv output messages using a predetermined correction value, and outputs the dv output messages corrected using the correction value to dv input nodes of a second processor.

### CROSS-REFERENCE TO RELATED APPLICATION(S) AND CLAIM OF PRIORITY

This application claims the benefit under 35 U.S.C. §119(a) of a Korean Patent Application filed in the Korean Intellectual Property Office on Jan. 30, 2007 and assigned Serial No. 2007-9491, the entire disclosure of which is hereby incorporated by reference.

### TECHNICAL FIELD OF THE INVENTION

The present invention relates to a communication system, and in particular, to an apparatus and method for receiving signals in a communication system.

### BACKGROUND OF THE INVENTION

Next-generation communication systems have evolved into a packet service communication system for transmitting burst packet data to a plurality of mobile stations. The packet service communication system has been designed to be suitable for high-capacity data transmission. Further, next-generation communication systems are positively considering the use of a Low Density Parity Check (LDPC) code, together with a turbo code, as a channel code. The LDPC code is known to have excellent performance gain for high-speed data transmission, and advantageously enhances data transmission reliability by effectively correcting errors caused by noises generated in a transmission channel. Examples of the next-generation communication systems positively considering the use of the LDPC code include the IEEE (Institute of Electrical and Electronics Engineers) 802.16e communication system, and the IEEE 802.11n communication system, etc.

With reference to FIG. 1, a description will now be made regarding a structure of a signal transmission apparatus in a general communication system using a LDPC code.

FIG. 1 is a block diagram illustrating a structure of a signal transmission apparatus in a general communication system using a LDPC code.

Referring to FIG. 1, the signal transmission apparatus (e.g., one or more base stations) includes an encoder 111, a modulator 113, and a transmitter 115. If information data to be transmitted by the signal transmission apparatus (i.e., an information vector s) is generated, the information vector s is delivered to the encoder 111. The encoder 111 generates a codeword vector c (i.e., an LDPC codeword) by encoding the information vector s using a predetermined encoding scheme, and outputs the codeword vector c to the modulator 113. The predetermined encoding scheme is herein an LDPC encoding scheme. The modulator 113 generates a modulation vector m by modulating the codeword vector c using a predetermined modulation scheme, and then outputs the modulation vector m to the transmitter 115. The transmitter 115 inputs therein the modulation vector m output from the modulator 113, performs transmission signal processing on the modulation vector m, and then transmits the resulting signal to a signal reception apparatus via an antenna ANT.

Next, a description will be made regarding a structure of a signal reception apparatus in a general communication system using a LDPC code, with reference to FIG. 2.

FIG. 2 is a block diagram illustrating a structure of a signal reception apparatus in a general communication system using a LDPC code.

Referring to FIG. 2, the signal reception apparatus (e.g., a mobile station) includes a receiver 211, a de-modulator 213, and a decoder 215. A signal transmitted by a signal transmission apparatus is received via an antenna ANT of the signal reception apparatus, and the received signal is delivered to the receiver 211. The receiver 211 performs reception signal processing for the received signal in order to generate a reception vector r, and then outputs the reception vector r to the demodulator 213. The demodulator 213 inputs therein the reception vector r output from the receiver 211, generates a demodulation vector x by demodulating the reception vector r using a demodulation scheme corresponding to a modulation scheme used in the modulator 113 of the signal transmission apparatus, and then outputs the modulation vector x to the decoder 215. The decoder 215 inputs therein the demodulation vector x output from the demodulator 213, decodes the input demodulation vector x using a decoding scheme corresponding to an encoding scheme used in the encoder ill of the signal transmission apparatus, and then outputs the decoded demodulation vector x as a finally restored information vector S. For the decoding scheme (i.e., an LDPC decoding scheme), an iterative decoding algorithm based on a sum-product algorithm or based on a min-sum algorithm is widely used and the sum-product algorithm and the min-sum algorithm will be described below in detail.

The LDPC code is a code defined by a parity check matrix in which most elements have a value of ‘0’, but a small minority of the other elements have a non-zero value, for example, a value of ‘1’. The LDPC code can be expressed using a bipartite graph that is expressed with variable nodes, check nodes, and edges connecting the variable nodes to the check nodes.

The LDPC code can be decoded on the bipartite graph by using an iterative decoding algorithm based on a sum-product algorithm. The sum-product algorithm is a kind of a message passing algorithm in which messages are exchanged over the edges in the bipartite graph, and output messages are calculated and updated from messages input into the variable nodes or the check nodes. Since a decoder for decoding the LDPC code uses the iterative decoding algorithm based on the message passing algorithm, it is less complex than a decoder for decoding a turbo code, and can be easily implemented as a parallel processing decoder.

Next, with reference to FIG. 3, a description will be made regarding a message passing operation in an arbitrary check node of a general decoder using an LDPC decoding scheme, hereinafter referred to as an ‘LDPC decoder’.

FIG. 3 illustrates a message passing operation in an arbitrary check node of a general LDPC decoder.

In FIG. 3, there are included a check node m 300 and a plurality of variable nodes 310, 320, 330, and 340 connected to the check node m 300. Further, T_{n′,m} indicates a message passed (or transferred) from the variable node n′ 310 to the check node m 300, and E_{n,m} indicates a message passed (or transferred) from the check node m 300 to the variable node n 330. A set of all variable nodes connected to the check node m 300 will be defined as N(m). A set given by excluding the variable node n 330 from N(m) will be defined as N(m)\n. In this case, a message update rule based on the sum-product algorithm can be expressed as follows:

$$\begin{matrix}Sign ( {E}_{n , m} ) = {\prod }_{{n}^{′} ∈ N ( m ) \backslash n} Sign ( {T}_{{m}^{′} , m} ) \\ \vert {E}_{n , m} \vert = Φ [ {\sum }_{{n}^{′} ∈ N ( m ) \backslash n} Φ ( \vert {T}_{{n}^{′} , m} \vert ) ] .\end{matrix} \qquad [ Eqn . 1 ]$$

In Equation 1, Sign(E_{n,m}) indicates a sign of a message E_{n,m} and indicates a magnitude of the message |E_{n,m}|. A function Φ(x) can be expressed as follows:

$$Φ ( x ) = - log [ tanh ( \frac{x}{2} ) ] . \qquad [ Eqn . 2 ]$$

A message update rule based on the min-sum algorithm can be expressed as follows:

$$\begin{matrix}Sign ( {E}_{n , m} ) = {\prod }_{{n}^{′} ∈ N ( m ) \backslash n} Sign ( {T}_{{n}^{′} , m} ) \\ \vert {E}_{n , m} \vert = {min}_{{n}^{′} ∈ N ( m ) \backslash n} \{ \vert {T}_{{n}^{′} , m} \vert \} = \vert {T}_{{n}_{0} , m} \vert .\end{matrix} \qquad [ Eqn . 3 ]$$

In Equation 3, no can be rewritten as follows:

$${n}_{0} = {argmin}_{{n}^{′} ∈ N ( m ) \backslash n} \{ \vert {T}_{{n}^{′} , m} \vert \} . \qquad [ Eqn . 4 ]$$

Although an input or output message of each node is used without an absolute sign of Equation 1, 3, or 4, a magnitude of the message can be expressed.

Next, input/output message passing operations in an arbitrary check node and a variable node of an LDPC code generated in a general LDPC decoder will be described with reference to FIGS. 4A and 4B. For convenience of explanation, a check node operation unit and a variable node operation unit will be separately described with reference to FIGS. 4A and 4B.

FIG. 4A illustrates a check node operation unit of the general LDPC decoder.

Referring to FIG. 4A, the check node operation unit includes a first memory 400, a check node processor 410, and a second memory 420. The first memory 400 stores messages to be input to the check node processor 410, and the second memory 420 stores messages output from the check node processor 410. The first memory 400 includes a plurality dc of sub-memories, e.g., sub-memory #1 T_{n,m} (400-1) through sub-memory #d_{c} [symbol] (400-d_{c}). The second memory 420 includes a plurality dc of sub-memories, e.g., sub-memory #1 Eₙ_{₁}_{,m} (420-1) through sub-memory #d_{c} [symbol] (420-d_{c}).

A variable node operation unit of a general LDPC decoder will now be described with reference to FIG. 4B.

FIG. 4B illustrates a variable node operation node of the general LDPC decoder.

Referring to FIG. 4B, the variable node operation unit includes a third memory 430, a variable node processor 440, and a fourth memory 450. The third memory 430 stores messages to be input to the variable node processor 440. The fourth memory 450 stores messages output from the variable node processor 440. The third memory 430 includes a plurality dᵥ of sub-memories, e.g., sub-memory #1 E_{n,m}_{₁} (430-1) through sub-memory #dᵥ [symbol] (430-dᵥ). The fourth memory 450 includes a plurality dv of sub-memories, e.g., sub-memory #1 T_{n,m}_{₁} (450-1) through sub-memory #dᵥ [symbol] (450-dᵥ).

On the assumption that an input degree of the check node processor 410 is dc in FIGS. 4A and 4B, d_{c} input messages are stored in the sub-memory #1 Tₙ_{₁}_{,m} (400-1) through sub-memory #d_{c} [symbol] (400-d_{c}), respectively, and output messages corresponding to the dc input messages are stored in the sub-memory #1 E_{n,m}_{₁} (430-1) through sub-memory #dᵥ [symbol] (430-dᵥ), respectively.

As discussed above, when the sum-product algorithm is used for a check node operation, check node output messages Eₙ_{₁}_{,m} (420-1), Eₙ_{₂}ₘ (420-2), Eₙ_{₃}_{,m} (420-3) and [symbol] (420-d_{c}) illustrated in FIG. 4A are calculated using Equation (1). The output message Eₙ_{₁}_{,m} (420-1) is calculated using the remaining d_{c}-1 messages except for the input message Tₙ_{₁}_{,m} (400-1) among the d_{c} input messages Tₙ_{₁}_{,m} (400-1), Tₙ_{₂}_{,m} (400-2), Tₙ_{₃}_{,m} (400-3) and [symbol] (400-d_{c}). The output message Eₙ_{₂}_{,m} (420-2) is calculated using the remaining d_{c}-1 messages except for the input message Tₙ_{₂}_{,m} (400-2) among the dc input messages Tₙ_{_{1,m}} (400-1), Tₙ_{₂}_{,m} (400-2), Tₙ_{₃}_{,m} (400-3) and [symbol] (400-d_{c}). The output message Eₙ_{₃}_{,m} (420-3) is calculated using the remaining d_{c}-1 input messages except for the input message Tₙ_{₃}_{,m} (400-3) among the dc input messages Tₙ_{₁}_{,m} (400-1), Tₙ_{₂}_{,m} (400-2), Tₙ_{₃}_{,m} (400-3) and [symbol] (400-d_{c})

As such, the output messages Eₙ_{₁}_{,m} (420-1) , Eₙ_{₂}_{,m} (420-2), Eₙ_{₃}_{,m} (420-3) and [symbol] (420-d_{c}) calculated using Equation (1) generally have different values and are input to dc variable nodes n₁, n₂, n₃ and n_{d}_{_{c}}, respectively.

When the check node operation unit is implemented with hardware, the dc output messages are input to the dc variable nodes along a data path and thus have different values, increasing routing complexity and thus reducing a data rate. Therefore, there is a need for a node operation method capable of coping with the increase in routing complexity.

### SUMMARY OF THE INVENTION

An aspect of the present invention is to address at least the above problems and/or disadvantages and to provide at least the advantages described below. Accordingly, an aspect of the present invention is to provide an apparatus and a method for receiving a signal in a communication system using an LDPC code.

Another aspect of the present invention is to provide an apparatus and a method for receiving a signal in a communication system using an LDPC code whereby routing complexity can be reduced.

Further another aspect of the present invention is to provide an apparatus and method for receiving a signal in a communication system using an LDPC code whereby routing complexity can be reduced using a minimum value detector and a corrector.

According to an aspect of the present invention, there is provided a method for receiving a signal in a signal reception apparatus of a communication system. The method includes inputting dc input messages through dc input nodes, respectively, at a first processor, generating one output message from the dc input messages using a predetermined operation scheme and outputting the output message to dc output nodes, at the first processor, inputting output messages output from the dc output nodes through dv input nodes and correcting the input dv output messages using a predetermined correction value, at a corrector, and outputting the dv output messages corrected using the correction value to dv input nodes of a second processor, at the corrector.

According to another aspect of the present invention, there is provided a signal reception apparatus of a communication system. The signal reception apparatus includes a first processor for inputting therein dc input messages through dc input nodes, respectively, and generating one output message from the dc input messages using a predetermined operation scheme and outputting the output message to dc output nodes, and a corrector for inputting therein output messages output from the dc output nodes through dv input nodes, correcting the input dv output messages using a predetermined correction value, and outputting the dv output messages corrected using the correction value to dv input nodes of a second processor.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a structure of a signal transmission apparatus in a general communication system using a Low Density Parity Check (LDPC) code;

FIG. 2 is a block diagram illustrating a structure of a signal reception apparatus in a general communication system using a LDPC code;

FIG. 3 illustrates a message passing operation in an arbitrary check node of a general LDPC decoder;

FIG. 4A illustrates a check node operation unit of the general LDPC decoder;

FIG. 4B illustrates a variable node operation node of the general LDPC decoder;

FIG. 5A illustrates a check node operation unit of an LDPC decoder according to a first exemplary embodiment of the present invention;

FIG. 5B illustrates a variable node operation unit of the LDPC decoder according to the first exemplary embodiment of the present invention;

FIG. 6A illustrates a check node operation unit of an LDPC decoder according to a second exemplary embodiment of the present invention; and

FIG. 6B illustrates a variable node operation unit of the LDPC decoder according to the second exemplary embodiment of the present invention.

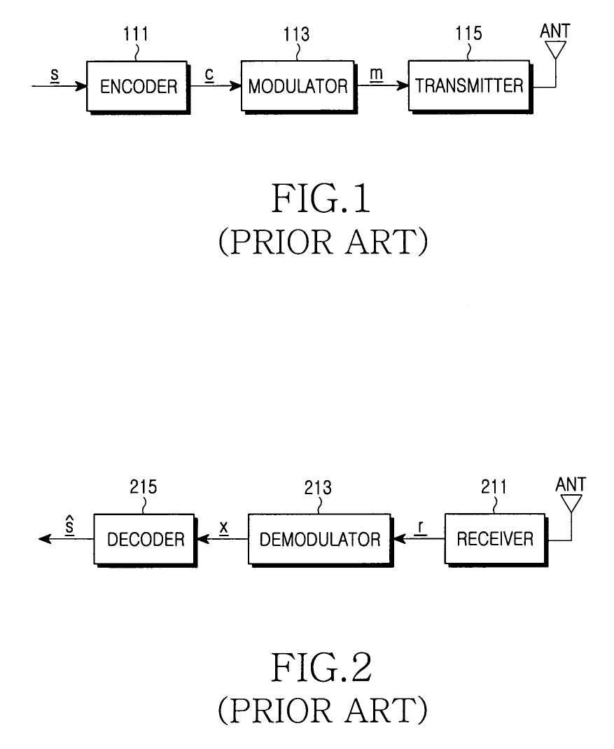

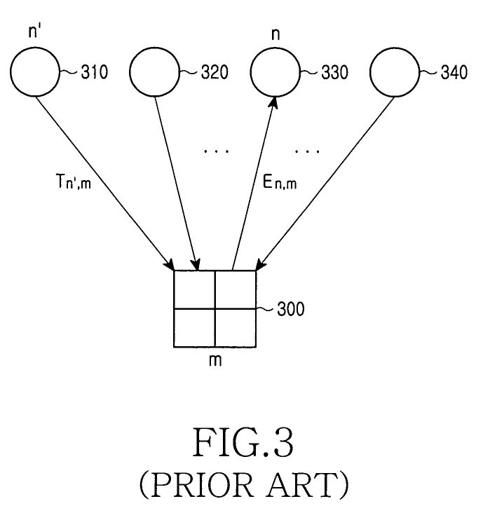

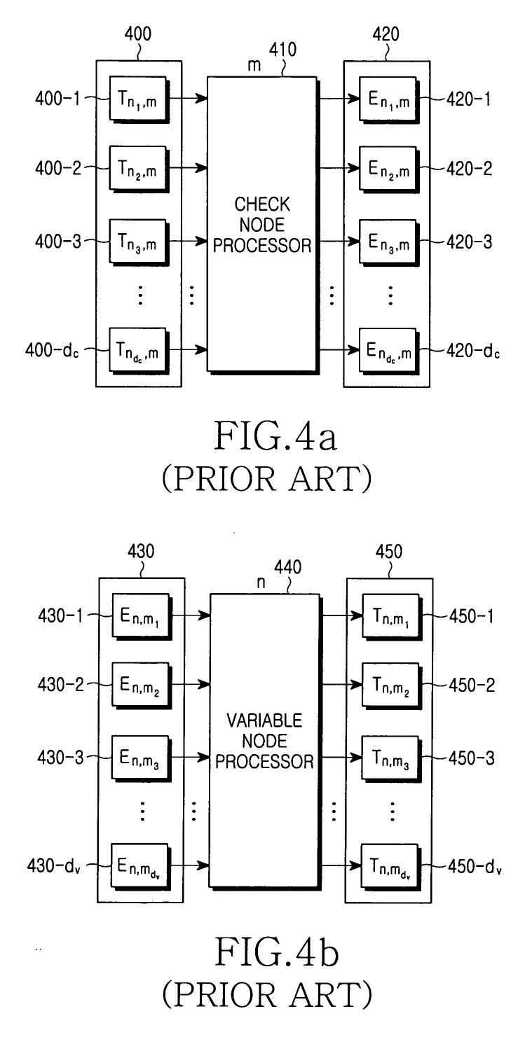

### DETAILED DESCRIPTION OF THE INVENTION

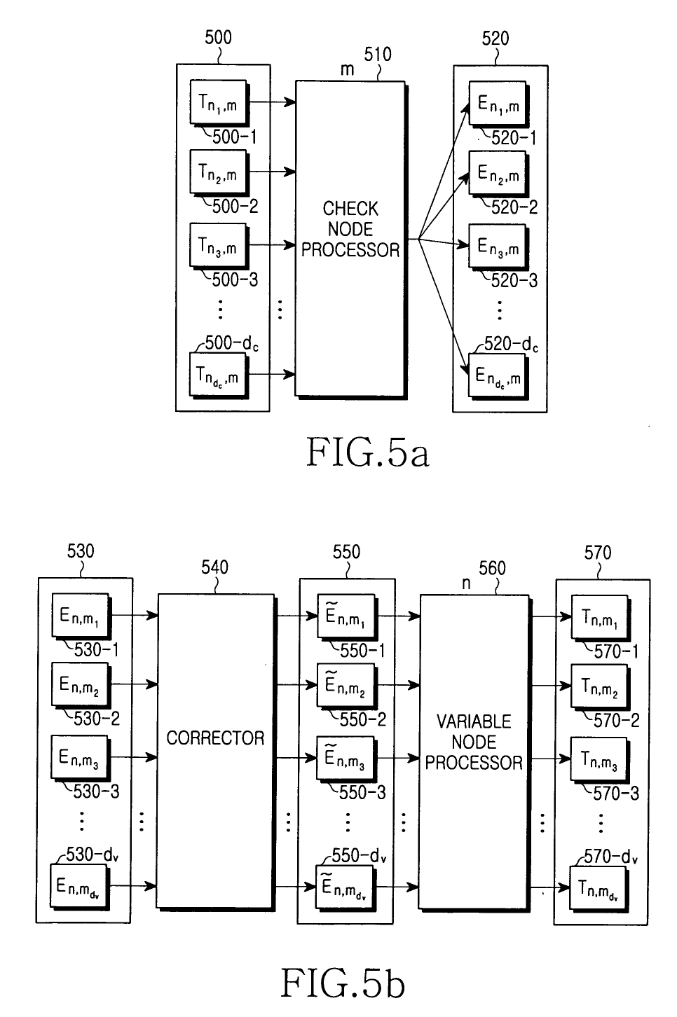

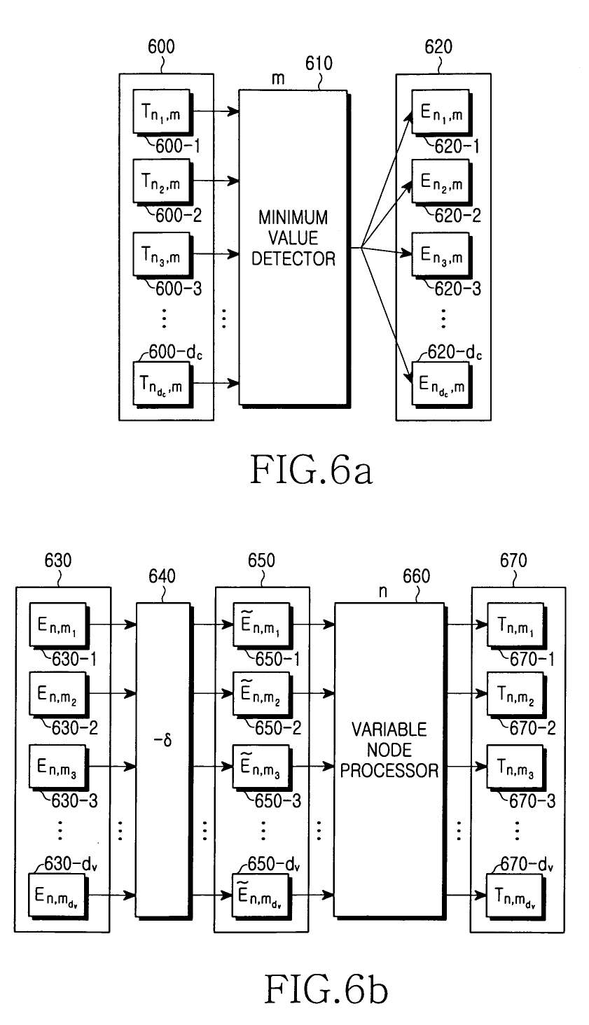

FIGS. 5a through 6b, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication systems.

The present invention suggests a method and apparatus for outputting a message from a check node to all variable nods connected to the check node in a communication system using a Low Density Parity Check (LDPC) code. The present invention also suggests a signal reception apparatus and method in which in order to reduce routing complexity during a check node operation required for message output, messages are input to a check node, a message having a minimum value among the messages is output using a predetermined operation method, e.g., a minimum value detection method, and the output message is corrected at each variable node, thereby decoding an LDPC code.

First, input or output message passing operations at a check node and a variable node of an LDPC code generated by an LDPC decoder according to a first exemplary embodiment of the present invention will be described with reference to FIGS. 5A and 5B. The LDPC decoder according to the first exemplary embodiment of the present invention includes a check node operation unit and a variable node operation unit. For convenience of explanation, the check node operation unit and the variable node operation unit will be separately described with reference to FIGS. 5A and 5B.

FIG. 5A illustrates the check node operation unit of the LDPC decoder according to the first exemplary embodiment of the present invention.

Referring to FIG. 5A, the check node operation unit includes a first memory 500, a check node processor 510, and a second memory 520. The first memory 500 stores messages to be input to the check node processor 510. The second memory 520 stores messages output from the check node processor 510. The first memory 500 includes a plurality dc of sub-memories, e.g., sub-memory #1 Tₙ_{₁}_{,m} (500-1) through sub-memory #dc [symbol] (500-d_{c}). The second memory 520 includes a plurality dc of sub-memories, e.g., sub-memory #1 Eₙ_{₁}_{,m} (520-1) through sub-memory #d_{c} [symbol] (520-d_{c}).

The check node processor 510 inputs therein d_{c} messages Tₙ_{₁}_{,m} (500-1), Tₙ_{₂}_{,m} (500-2) Tₙ_{₃}_{,m} (500-3) and [symbol] (500-d_{c}). The check node processor 510 outputs d_{c} messages Eₙ_{₁}_{,m} (520-1), Eₙ_{₂}_{,m} (520-2), Eₙ_{₃}_{,m} (520-3) and [symbol] (520-d_{c}). The dc messages output from the check node processor 510 have the same value. In other words, a relationship of Eₙ_{₁}_{,m}=Eₙ_{₂}_{,m}=Eₙ_{₃}ₘ= . . . = [symbol] can be established.

The check node processor 510 outputs the same message for the dc input messages, thereby reducing its complexity.

Next, input or output message passing operations in an arbitrary variable node of an LDPC decoder according to the first exemplary embodiment of the present invention will be described with reference to FIG. 5B.

FIG. 5B illustrates the variable node operation unit of the LDPC decoder according to the first exemplary embodiment of the present invention.

The variable node operation unit includes a third memory 530, a corrector 540, a fourth memory 550, a variable node processor 560, and a fifth memory 570. The third memory 530 stores messages to be input to the corrector 540, and the messages stored in the third memory 530 are the same as the messages stored in the second memory 520 illustrated in FIG. 5A. The fourth memory 550 contains messages output from the corrector 540, i.e., messages to be input to the variable node processor 560. The fifth memory 570 stores messages output from the variable node processor 560.

The third memory 530 includes a plurality dᵥ of sub-memories, e.g., sub-memory #1 E_{n,m}₁ (530-1) through sub-memory #dᵥ [symbol] (530-dᵥ). The fifth memory 570 includes a plurality dᵥ of sub-memories, e.g., sub-memory #1 T_{n,m}_{₁} (570-1) through sub-memory #dᵥ [symbol] (570-dᵥ).

The dᵥ messages E_{n,m}_{₁} (530-1), E_{n,m}_{₂} (530-2), E_{n,m}_{₃} (530-3) and [symbol] (530-dᵥ) stored in the third memory 530 are input to the corrector 540. The corrector 540 inputs a predetermined correction value to the output messages having the same value from the check node processor 510, thereby outputting messages \tilde{E}_{n,m}_{₁} (550-1), \tilde{E}_{n,m}_{₂} (550-2), \tilde{E}_{n,m}_{₃} (550-3) and [symbol] (550-dᵥ). The predetermined correction value is determined by a system. There may be a plurality of parameters of the correction value determined by the system, and parameter determination for the correction value will not be described due to its irrelevance to the present invention. The output messages \tilde{E}_{n,m}_{₁} (550-1), \tilde{E}_{n,m}_{₂} (550-2), \tilde{E}_{n,m}_{₃} (550-3) and [symbol] (550-dᵥ) are input to the variable node processor 560. The variable node processor 560 performs a variable node operation using the output messages, thereby outputting T_{n,m}_{₁} (570-1) T_{n,m}_{₂} (570-2), T_{n,m}_{₃} (570-3) and [symbol] (570-dᵥ).

While input or output message passing operations in an arbitrary check node and an arbitrary variable node of an LDPC code generated by the LDPC decoder according to the first exemplary embodiment of the present invention have been described with reference to FIGS. 5A and 5B, input or output message passing operations at a check node and a variable node of an LDPC code generated by an LDPC decoder according to a second exemplary embodiment of the present invention will now be described with reference to FIGS. 6A and 6B. The LDPC decoder according to the second exemplary embodiment of the present invention includes a check node operation unit and a variable node operation unit. For convenience of explanation, the check node operation unit and the variable node operation unit will be separately described with reference to FIGS. 6A and 6B. Although a min-sum algorithm will be used by way of example in FIGS. 6A and 6B, the present invention can also be realized using other algorithms than the min-sum algorithm.

FIG. 6A illustrates the check node operation unit of the LDPC decoder according to the second exemplary embodiment of the present invention.

Referring to FIG. 6A, the check node operation unit includes a first memory 600, a minimum value detector 610, and a second memory 620. The first memory 600 stores messages to be input to the minimum value detector 610. The second memory 620 stores messages output from the minimum value detector 610. The first memory 600 includes a plurality dc of sub-memories, e.g., sub-memory #1 Tₙ_{₁}_{, m} (600-1) through sub-memory #d_{c} [symbol] (600-d_{c}). The second memory 620 includes a plurality dc of sub-memories, e.g., sub-memory #1 Eₙ_{₁}_{,m} (620-1) through sub-memory #d_{c} [symbol] (620-d_{c}).

The minimum value detector 610 inputs therein dc messages Tₙ_{₁}_{,m} (600-1), Tₙ_{₂}_{,m} (600-2) Tₙ_{₃}_{,m} (600-3) and [symbol] (600-d_{c}), and detects a minimum value from among the input messages. A value output from the minimum value detector 610 is copied into dc values that are equal to one another, thereby outputting messages Eₙ_{₁}_{,m} (620-1), Eₙ_{₂}_{,m} (620-2), Eₙ_{₃}_{,m} (620-3) and [symbol] (620-d_{c}).

Next, input or output message passing operations in an arbitrary variable node of the LDPC decoder according to the second exemplary embodiment of the present invention will be described with reference to FIG. 6B.

FIG. 6B illustrates the variable node operation unit of the LDPC decoder according to the second exemplary embodiment of the present invention.

Referring to FIG. 6B, the variable node operation unit includes a third memory 630, a corrector 640, a fourth memory 650, a variable node processor 660, and a fifth memory 670. The third memory 630 stores messages to be input to the corrector 640, and the fourth memory 650 contains messages output from the corrector 640, i.e., messages to be input to the variable node processor 660. The fifth memory 670 stores messages output from the variable node processor 660.

The third memory 630 includes a plurality dᵥ of sub-memories, e.g., sub-memories #1 E_{n,m}_{₁} (630-1) through #dᵥ [symbol] (630-dᵥ). The fourth memory 650 includes a plurality dᵥ of sub-memories, e.g., sub-memories #1 \tilde{E}_{n,m}_{₁} (650-1) through #dᵥ [symbol] (650-dᵥ). The fifth memory 670 includes a plurality dᵥ of sub-memories, e.g., sub-memories #1 T_{n,m}_{₁} (670-1) through #dᵥ [symbol] (670-dᵥ).

The corrector 640 performs correction by subtracting a predetermined correction value from the dv messages E_{n,m}_{₁} (630-1), E_{n,m}_{₂} (630-2), E_{n,m}_{₃} (630-3) and [symbol] (630-dᵥ). The correction value is predetermined by a system, and it is assumed that correction is performed by subtraction of a constant δ in the present invention. The corrector 640 outputs corrected values \tilde{E}_{n,m}_{₁} (650-1), \tilde{E}_{n,m}_{₂} (650-2), \tilde{E}_{n,m}_{₃} (650-3) and [symbol] (650-dᵥ). The variable node processor 660 inputs therein the corrected values \tilde{E}_{n,m}_{₁} (650-1), \tilde{E}_{n,m}_{₂} (650-2), \tilde{E}_{n,m}_{₃} (650-3) and [symbol] (650-dᵥ) and performs a operation, thereby outputting T_{n,m}_{₁} (670-1), T_{n,m}_{₂} (670-2), T_{n,m}_{₃} (670-3) and [symbol] (670-dᵥ).

For example, it is assumed that d_{c} is 4 and input message magnitudes are Tₙ_{₁}_{,m}=5, Tₙ_{₂}_{,m}=9, Tₙ_{₃}_{,m}=3, and Tₙ_{₄}_{,m}=7 for description with reference to FIGS. 6A and 6B. When a min-product algorithm is used according to prior art, the output message Eₙ_{₁}_{,m} is a minimum value of 3 among Tₙ_{₂}_{,m}=9, Tₙ_{₃}_{,m}=3, and Tₙ_{₄}_{,m}=7 except for Tₙ_{₁}_{,m}=5. However, when a min-product algorithm is used according to the present invention, a minimum value of 3 among Tₙ_{₁}_{,m}=5, Tₙ_{₂}_{,m}=9, Tₙ_{₃}_{,m}=3, and Tₙ_{₄}_{,m}=7 is detected and is then copied into 4 (=dc) values, thereby outputting Eₙ_{₁}_{,m}=Eₙ_{₂}_{,m}=Eₙ_{₃}_{,m}=Eₙ_{₄}_{,m}=3.

It is assumed that the degree of a variable node n is dᵥ=3 and messages input to the corrector 640 are E_{n,m}_{₁}=8, E_{n,m}_{₂}=5, and E_{n,m}_{₃}=6. If a correction value δ used in the corrector 640 is set to 2, the corrector 640 outputs \tilde{E}_{n,m}_{₁}=6, \tilde{E}_{n,m}_{₂}=3, and \tilde{E}_{n,m}_{₃}=4 and these output values are input to the variable node processor 660.

As is apparent from the foregoing description, the present invention can reduce the routing complexity of a decoder by outputting the same message to each variable node during a check node operation and performing correction with a predetermined correction value at a variable node during decoding of an LDPC code in a communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for receiving a signal in a signal reception apparatus of a communication system, the method comprising:
inputting dc input messages through d_{c} input nodes, respectively, at a first processor;
generating one output message from the d_{c} input messages using a predetermined operation scheme and outputting the output message to d_{c} output nodes, at the first processor;
inputting output messages output from the d_{c} output nodes through dᵥ input nodes and correcting the input dᵥ output messages using a predetermined correction value, at a corrector; and
outputting the dᵥ output messages corrected using the correction value to dᵥ input nodes of a second processor, at the corrector.

2. The method of claim 1, wherein the predetermined operation scheme includes generating an input message having a minimum value among the d_{c} input messages as the one output message.

3. The method of claim 1, wherein d_{c} indicates a number of check nodes.

4. The method of claim 1, wherein dᵥ indicates a number of variable nodes.

5. A signal reception apparatus of a communication system, the signal reception apparatus comprising:
a first processor for inputting therein d_{c} input messages through d_{c} input nodes, respectively, and generating one output message from the d_{c} input messages using a predetermined operation scheme and outputting the output message to d_{c} output nodes; and
a corrector for inputting therein output messages output from the d_{c} output nodes through dᵥ input nodes, correcting the input dᵥ output messages using a predetermined correction value, and outputting the dᵥ output messages corrected using the correction value to dᵥ input nodes of a second processor.

6. The signal reception apparatus of claim 5, wherein the predetermined operation scheme includes generating an input message having a minimum value among the d_{c} input messages as the one output message.

7. The signal reception apparatus of claim 5, wherein d_{c} indicates a number of check nodes.

8. The signal reception apparatus of claim 5, wherein dᵥ indicates a number of variable nodes.

9. A base station for use in a wireless network that communicates with a plurality of mobile stations, wherein the base station comprises a signal reception apparatus, the signal reception apparatus comprising:
a first processor for inputting therein d_{c} input messages through d_{c} input nodes, respectively, and generating one output message from the d_{c} input messages using a predetermined operation scheme and outputting the output message to d_{c} output nodes; and
a corrector for inputting therein output messages output from the d_{c} output nodes through dᵥ input nodes, correcting the input dᵥ output messages using a predetermined correction value, and outputting the dᵥ output messages corrected using the correction value to dᵥ input nodes of a second processor.

10. The base station of claim 9, wherein the predetermined operation scheme includes generating an input message having a minimum value among the d_{c} input messages as the one output message.

11. The base station of claim 9, wherein dc indicates a number of check nodes.

12. The base station of claim 9, wherein dᵥ indicates a number of variable nodes.

13. The base station of claim 9, wherein the base station implements a method for receiving a signal in the signal reception apparatus of a communication system, the method comprising:
inputting d_{c} input messages through d_{c} input nodes, respectively, at a first processor;
generating one output message from the d_{c} input messages using a predetermined operation scheme and outputting the output message to d_{c} output nodes, at the first processor;
inputting output messages output from the d_{c} output nodes through dᵥ input nodes and correcting the input dᵥ output messages using a predetermined correction value, at a corrector; and
outputting the dᵥ output messages corrected using the correction value to dᵥ input nodes of a second processor, at the corrector.

14. A mobile station for use in a wireless network that communicates with a plurality of mobile stations, wherein the mobile station comprises a signal reception apparatus, the signal reception apparatus comprising:
a first processor for inputting therein d_{c} input messages through d_{c} input nodes, respectively, and generating one output message from the d_{c} input messages using a predetermined operation scheme and outputting the output message to d_{c} output nodes; and
a corrector for inputting therein output messages output from the d_{c} output nodes through dv input nodes, correcting the input dᵥ output messages using a predetermined correction value, and outputting the dᵥ output messages corrected using the correction value to dᵥ input nodes of a second processor.

15. The mobile station of claim 14, wherein the predetermined operation scheme includes generating an input message having a minimum value among the d_{c} input messages as the one output message.

16. The mobile station of claim 14, wherein d_{c} indicates a number of check nodes.

17. The mobile station of claim 14, wherein dᵥ indicates a number of variable nodes.
